(19) United States
(12) Patent Application Publication
(10) Pub. No.: US 2016/0164112 A1
(43) Pub. Date: Jun. 9, 2016

(54) Cell and Cell Stack of a Redox Flow Battery

(71) Applicant: Fraunhofer-Gesellschaft zur Forderung der angewandten Forschung e.V., Munchen (DE)

(72) Inventors: Thorsten Seipp, Dortmund (DE); Sascha Berthold, Oberhausen (DE); Jens Burfeind, Oberhausen (DE); Lukas Kopietz, Duisburg (DE)

(73) Assignee: Fraunhofer-Gesellschaft zur Forderubg der angewandten Forschung e.V., Munchen (DE)

(21) Appl. No.: 14/905,025

(22) PCT Filed: Jul. 4, 2014
(86) PCT No.: PCT/EP2014/064299

§ 371 Date: Jan. 14, 2016

(30) Foreign Application Priority Data
Jul. 16, 2013 (DE) 10 2013 107 516.9

(51) Int. Cl. H01M 8/0273; H01M 8/20; H01M 8/18

(52) U.S. Cl. CPC H01M 8/0273; H01M 8/188; H01M 8/20

(57) ABSTRACT

Provided herein is a cell of a redox flow battery, having at least one cell frame element, a membrane and two electrodes. The at least one cell frame element, the membrane and the two electrodes surround two cell inner spaces which are separate from each other. In the at least one cell frame element, at least four separate channels are provided in such a manner that different electrolyte solutions can flow through the two cell inner spaces. With the exception of the at least four separate channels, the cell is constructed in a fluid-tight manner. At least the at least one cell frame element is welded to the membrane, the two electrodes, and/or at least one additional cell frame element to provide the redox flow battery with a higher power of density.

The invention relates to a cell of a redox flow battery, having at least one cell frame element, a membrane and two electrodes, wherein the at least one cell frame element, the membrane and the two electrodes close off two cell inner spaces which are separate from each other, wherein, in the at least one cell frame element, at least four separate channels are provided in such a manner that different electrolyte solutions can flow through the two cell inner spaces and wherein the cell with the exception of the at least four separate channels is constructed in a fluid-tight manner. The invention further relates to a cell stack of a redox flow battery with at least one such cell.

Redox flow batteries are already known in various configurations. Such configurations are described, for example, in AT 510 250 A1 and US 2004/0170893 A1. An important advantage of redox flow batteries involves their suitability for being able to store very large quantities of electrical energy. In this instance, the energy is stored in electrolytes which can be held in a state of readiness in very large tanks in a space-saving manner. The electrolytes generally have metal ions of different oxidation stages. In order to remove electrical energy from the electrolytes or to re-charge the electrolytes, the electrolytes are pumped by a so-called electrochemical cell. For the sake of simplicity, only the term “cell” is used below in place of the term “electrochemical cell”.

In this instance, the cell is formed from two half-cells which are separated from each other by means of a membrane and each comprise a cell inner space, an electrolyte and an electrode. The membrane is semi-permeable and serves to spatially and electrically separate the cathode and anode of an electrochemical cell from each other. To this end, the membrane must be permeable with respect to specific ions which bring about the conversion of the stored chemical energy into electrical energy. Membranes can be formed, for example, from microporous plastics materials or polyethylene. At both electrodes of the cell, that is to say, at the anode and the cathode, redox reactions take place, with electrons being released by the electrolytes at one electrode and electrons being absorbed at the other electrode. The metal and/or non-metal ions of the electrolytes form redox pairs and consequently produce a redox potential. It is possible to consider, for example, iron/chromium, polysulphide/bromide, vanadium or other heavy metals as redox pairs. Those pairs or other redox pairs can in principle be present in an aqueous or non-aqueous solution.

The electrodes of a cell, between which a potential difference is formed as a result of the redox potentials, are electrically connected to each other outside the cell, for example, by means of an electrical consumer. While the electrons move from one half-cell to the other outside the cell, ions of the electrolytes travel through the membrane directly from one half-cell to the other half-cell. In order to re-charge the redox flow battery, a potential difference, by which the redox reactions which take place at the electrodes of the half-cells are reversed, can be applied to the electrodes of the half-cells, in place of the electrical consumer, for example, by means of a charging device.

In order to form the cell described, cell frames are used which enclose a cell inner space peripherally. In this instance, each half-cell comprises such a cell frame which is generally produced from a thermoplastic plastics material using the injection-moulding method. There is arranged between two cell frames the membrane which separates electrolytes of the half-cells from each other in relation to a convective material exchange but which allows a diffusion of specific ions from one half-cell to the other half-cell. Furthermore, an electrode is associated with the cell inner spaces in such a manner that they are in contact with the electrolytes which flow through the cell inner spaces. The electrodes can, for example, close off the cell inner space of each cell frame at the side directed away from the membrane. Each cell frame has openings and channels through which the corresponding electrolyte can flow from a supply line into the respective cell inner space and from there can be removed again and be supplied to a discharge line. The electrolytes of the half-cells are pumped round in this instance via the supply line and the discharge line from a collection container into a storage container. This allows repeated use of the electrolytes which consequently neither have to be discarded nor replaced.

Where necessary, a plurality of identically constructed cells is combined in a redox flow battery. Generally, the cells are stacked on each other for this purpose, for which reason the entirety of the cells is also referred to as a cell stack. The individual cells are generally flowed through by the electrolytes parallel with each other while the cells are generally electrically connected one behind the other. Therefore, the cells are usually connected hydraulically in a parallel manner and electrically in series. In this case, the charging state of the electrolytes is identical in each one of the half-cells of the cell stack.

Half-cells are connected to each other with channels in order to distribute the electrolytes over the corresponding half-cells of the cell stack and to discharge the electrolytes together from the respective half-cells. Since each half-cell or each cell inner space of a cell is flowed through by another electrolyte, the two electrolytes have to be separated from each other during the passage through the cell stack. To that end, there are generally provided in the cell frames or cell frame elements four holes which form, in each cell frame element and/or in the cell stack, a channel perpendicularly to the respective cell, to the respective cell inner space and/or along the cell stack. Two of the channels serve to transport an electrolyte. In this instance, the electrolyte is supplied via a channel to the cell inner space while the electrolyte is discharged from the cell inner space via the other channel. In each half-cell, therefore, distribution channels which are connected to the cell inner space branch off from two channels in order thus to allow the supply and discharge of electrolytes to the half-cells or the throughflow through the cell inner spaces with electrolytes.

So that the cells and where applicable the stacks are fluid-tight, the corresponding cell frames and where applicable in addition the corresponding electrodes and membranes are pressed on each other, wherein contact between specific electrolytes and specific electrodes has to be prevented. In order to seal the channels and/or the cell inner spaces, seals are generally used, for instance, in the form of O-rings, flat seals, injection-moulded seals or the like. In order to be able to ensure the fluid-tightness of the cells or cell stacks, extremely high surface pressures have to be provided at the seals. Therefore, the cells or cell stacks are introduced in a clamping device between terminal clamping plates which are pressed against the cell or cell stack by means of tension rods which extend laterally along relative to the cell stack.

Known redox flow batteries are relatively large in relation to the power thereof. Therefore, there are efforts to further increase the power density of the redox flow batteries.

Therefore, an object of the present invention is to provide a cell and a cell stack of the type mentioned in the introduction and described in greater detail above which allow redox flow batteries with a higher power density.

This object is achieved in a cell according to the preamble of claim 1 in that at least the at least one cell frame element is welded to the membrane, the two electrodes and/or at least one additional cell frame element.

The above-mentioned object is further achieved according to claim 14 by a cell stack with at least one such cell.

The invention has recognised that, by welding the at least one cell frame element to the membrane, the two electrodes and/or at least one additional cell frame element, it is possible to dispense with pressing of the cells or cell stack and that the cells can thereby be constructed to be thinner. This is because the cell frame elements are then no longer subjected to such high mechanical loads. The invention further opens up completely new design possibilities with regard to the construction of the cell frame elements because they no longer have to be subjected to such high surface pressures in the region of the sealing faces. For example, the frame of the at least one cell frame element may be constructed to be narrower, for instance, in order to increase the relative surface proportion of the cell inner space.

In principle, at least one cell frame element can also be pressed or otherwise connected according to the invention to a membrane, an electrode and/or at least one additional cell frame element in order to obtain sufficient sealing. Whether and how this is carried out may be established in accordance with the individual case. In any case, however, there is carried out a partial welding as described above, in particular between the components of the cell where the compression thereof results in particular disadvantages. The membrane may preferably be a semi-permeable membrane, an ion-conducting membrane and/or a porous membrane.

The electrodes are further preferably bipolar plates. The electrodes adjoin, at least at one cell inner space preferably at both sides, cell inner spaces of different half-cells or cells if a cell stack is provided, wherein the electrode closes off the at least one half-cell or at least the corresponding cell inner space at one side. The membrane closes off at both sides a half-cell or a cell inner space of the cell. In the case of a cell stack, it preferably comprises at least 5, in particular at least 10, cells.

If, in the context of the invention, welding is referred to, preferably a peripheral welding is intended to be understood in order to provide a peripheral fluid-tightness. In particular, the term “peripheral” is intended to be understood to be substantially in a plane parallel with a plane of the cell or the half-cell and/or parallel with a cell inner space. Furthermore, in particular the edges of the corresponding components are welded to each other so that the term “peripheral” is particularly intended to be understood to be peripheral with respect to at least one of those edges.

In a first preferred embodiment of the cell, the at least one cell frame element is welded to the membrane, the two electrodes and/or to at least one additional cell frame element by means of laser welding, hot air welding, heat element welding and/or ultrasound welding. This can be carried out in accordance with the norms EN 14610 and/or DIN 1910-100. A welding operation in the manner mentioned is simple and cost-effective to carry out and allows the provision of a fluid-tight connection. In this instance, the laser can be adjusted in such a manner that the laser beam is absorbed in the penetrated material to a significant extent only in portions in order to introduce thermal energy for the welding into the material at those locations in a locally limited manner.

This is in particular a so-called laser transmission welding, wherein the heating and joining operation can be carried out practically simultaneously, in the closing orientation of the components relative to each other. The heating can be carried out, for example, by absorption of the laser beam at specific pigments, in particular pigments of a specific colour. Therefore, selectively corresponding pigments can be provided at the location to be welded in order to generate a selective introduction of heat. It is also possible to use a joining partner with a high transmission degree and a joining partner with a high absorption degree for the laser beam used. The component with the high absorption degree can be coloured, for example, by specific pigments which absorb the laser beam, or be interspersed with pigments in another manner. However, the component with the high transmission degree can be substantially free from such pigments. Since the laser beam is absorbed only locally, the components to be welded can already be positioned in the final position relative to each other before the heating. The laser beam is then introduced through the component or the components with a high transmission degree as far as the component or the components with a high absorption degree, where the laser beam is absorbed at least partially. In order to obtain a good level of weldability, the at least one cell frame element, the at least one electrode and/or the membrane can be formed from plastics material and/or a composite material which contains plastics material. The composite material may be where applicable a compound material. In the case of a composite material or a compound material, it may be constructed in a single layer or with multiple layers. In the last case mentioned, the layers differ from each other with regard to the composition or structure thereof. However, a single-layer, preferably homogeneous construction of the at least one cell frame element, the at least one electrode and/or the membrane is particularly simple and cost-effective. A compound material is formed from a compound substance.

The weldability can be further increased if the plastics material is a thermoplastic material. For reasons of weldability and the mechanical properties, the thermoplastic material is preferably a polyolefin, in particular polyethylene (PE), polypropylene (PP), polyphenylene sulphide (PPS), polyether ether ketone (PEEK), polyvinyl chloride (PVC) and/or polyamide (PA).

If the membrane and/or the at least one electrode is not welded to the at least one adjacent cell frame element, the membrane and/or the at least one electrode can be extruded or cast so as to be sealed in a fluid-tight manner from a cell frame element. In this instance, the extrusion is preferably carried out by injection-moulding. In this manner, the fluid-tightness can be provided in a simple manner. Alternatively or additionally, the membrane and/or the at least one electrode can be retained in a fluid-tight manner by means of pressing between two cell frame elements which are welded to each other. A corresponding pressing force then has to be provided so that this option may be less preferable. However, it may be the case that the pressing force can be provided in a simple manner, for instance, by welding other components, preferably by cell frame elements which are welded to each other, the cell or adjacent cells of the cell stack. Generally, the welding will be preferred with respect to extrusion and/or casting. This is because the corresponding weld seams generally better withstand mechanical loads so that the risk of occurrences of non-tightness in the event of extrusion and/or casting is greater.

In order to increase the power density of the redox flow battery, to simplify the construction of the redox flow battery and/or to simplify the welding, the at least four channels may have openings on at least one narrow side, in particular at least two narrow sides, of the cell and/or the at least one cell frame element. The end sides of the cell and/or the cell frame elements surrounded by the narrow sides can then be constructed without any openings for the electrolytes so that there is no risk of contact between the electrolyte and the electrode and/or membrane at that location. The end sides are in this instance preferably constructed to be substantially parallel with the cell inner spaces, the electrodes and/or the at least one membrane. Therefore, there does not have to be provided any separate region at the end sides of the cell frame elements for the openings and the channels which are provided perpendicularly to the cell inner space. Consequently, the cell frame elements can be constructed to be narrower and the power density can be increased. Furthermore, as a result of corresponding channels, only one electrolyte has to be directed through the frame of a cell frame element, in a direction towards the corresponding cell inner space and away from the cell inner space. This means that the at least four channels for causing an electrolyte to flow through the two cell inner spaces of a cell can be divided over at least two cell frame elements of the cell. This can be carried out in such a manner that each cell frame element has at least two channels and/or holes, in particular for an electrolyte.

In another preferred embodiment of the cell, the membrane and/or at least one electrode is welded to at least one cell frame element. In this manner, the membrane and/or the at least one electrode can be fixed and the cell inner space of the at least one corresponding half-cell can further be sealed. Furthermore, a cell can thus be constructed easily, for example, by a cell frame element surrounding the cell inner space and that cell inner space being closed off in a fluid-tight manner laterally by welding the cell frame element to a membrane and/or an electrode at least at one side. Thus, for example, the cell can be provided by two cell frame elements which are welded to the membrane and the electrodes by the cell frame elements being welded to each other separately or by means of the membrane. Such a cell is then fluid-tight, with the exception of the channels, and can readily be combined with other cells to form a cell stack. Finally, therefore, at least two cell frame elements can be provided, wherein a cell frame element is welded to the membrane, to an electrode and to an additional cell frame element, which is preferably welded to the additional electrode.

As a basic principle, two cell frame elements can be welded to each other in order to be able to readily construct the cell and to readily seal it. Alternatively or additionally, the membrane can be welded to two cell frame elements. Thus, for example, it is readily possible to seal the centre of the cell. The outer sides of the cell can readily be sealed if alternatively or additionally the electrodes are welded to at least one cell frame element. In other words, at least two cell frame elements can be welded to an electrode and to the membrane, respectively.

In a preferred construction of the cell, at least five cell frame elements are provided. The two electrodes and the membrane are each welded to a separate cell frame element. The five cell frame elements can further be welded to each other. It is then possible to construct the cell using two cell frame elements which are each welded to an electrode, wherein those two cell frame elements are each welded to a cell frame element which peripherally surrounds a cell inner space. The latter cell frame elements can then be welded to a cell frame element which is provided therebetween and which is welded to a membrane. Therefore, there is produced a modular construction. The electrodes are provided by a type of cell frame elements which are welded to an electrode. The cell inner spaces and/or the distribution channels for the electrolytes are substantially provided by other cell frame elements while the membrane is provided via another cell frame element which is welded to the membrane. Naturally, additional cell frame elements can further also be provided for the construction of a cell. However, this is more complex and therefore less preferable. In the case of a cell stack, the cell frame elements which are welded to an electrode are further dispensable in the adjacent cells. As a result, the adjacent cells and where applicable the additional cells then manage with four additional cell frames which are constructed as described above. They then provide two additional cell inner spaces, a membrane and an additional electrode.

In order to be able to weld the electrode simply to a cell frame element, it is advantageous if the electrode is at least partially formed from at least one plastics material, in particular from at least one thermoplastic material, preferably polyethylene (PE), polypropylene (PP), polyphenylene sulphide (PPS), polyether ether ketone (PEEK), polyvinyl chloride (PVC) and/or polyamide (PA). In a further preferable manner, the electrode is formed from a composite of a plastics material and conductive particles, preferably in the form of carbon, graphite, soot, titanium carbide (TiC), boron nitride (BN), at least one metal and/or at least one metal compound. The conductive particles, which are preferably homogeneous, are preferably arranged so as to be distributed as a dispersed phase in a continuous phase or matrix of the at least one plastics material.

In principle, adjacent cell frame elements of a cell or adjacent cells can be welded directly to each other. However, there may also be provision for adjacent cell frame elements of a cell and/or of adjacent cells to be welded to each other via an electrode or a membrane. However, each cell frame element is then welded to the electrode or the membrane but is not welded to the other cell frame element.

It is advantageous, for the simple construction of a cell stack, for at least one cell of the type described above, in particular a cell frame element or an electrode of the cell, to be welded to a cell frame element of an adjacent cell. In this instance, the adjacent cell can be constructed in the same manner as the cell of the type described above. Preferably, all the cells of the cell stack are constructed in the same manner.

Alternatively or additionally, the cells of a cell stack can be welded at opposing sides to a cell frame element of an adjacent cell, which element is preferably welded to a membrane. In this instance, the terminal cells of the cell stack may constitute an exception. They may preferably adjoin an end plate. They may have a planar contact with the adjacent terminal electrode and be connected, for example, to at least one consumer via at least one line.

The invention is explained in greater detail below with reference to drawings which merely set out embodiments. In the drawings:

FIG. 1 is a longitudinal section of a cell stack of a redox flow battery known from the prior art,

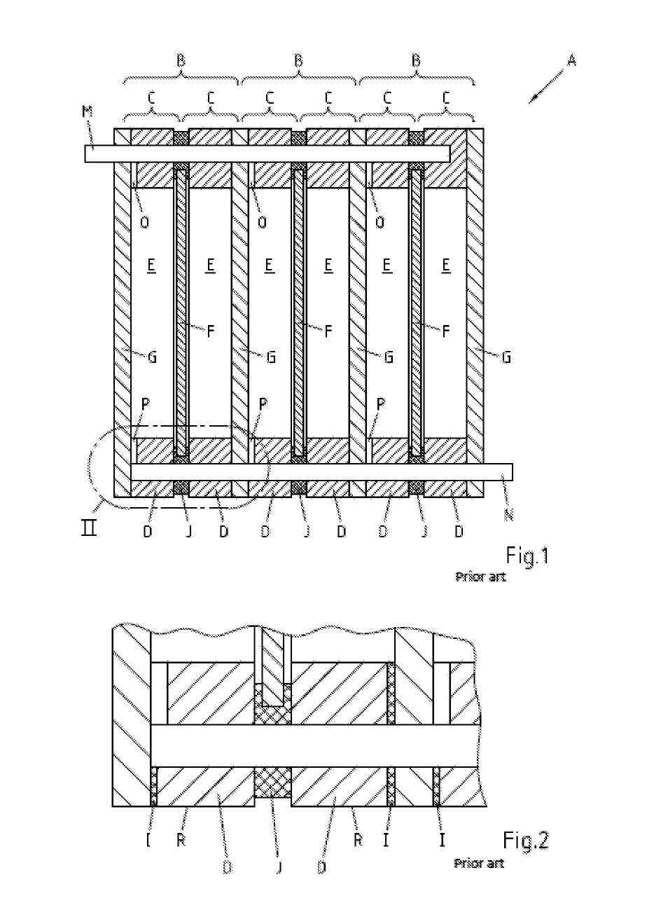

FIG. 2 is a detailed illustration of the cell stack from FIG. 1,

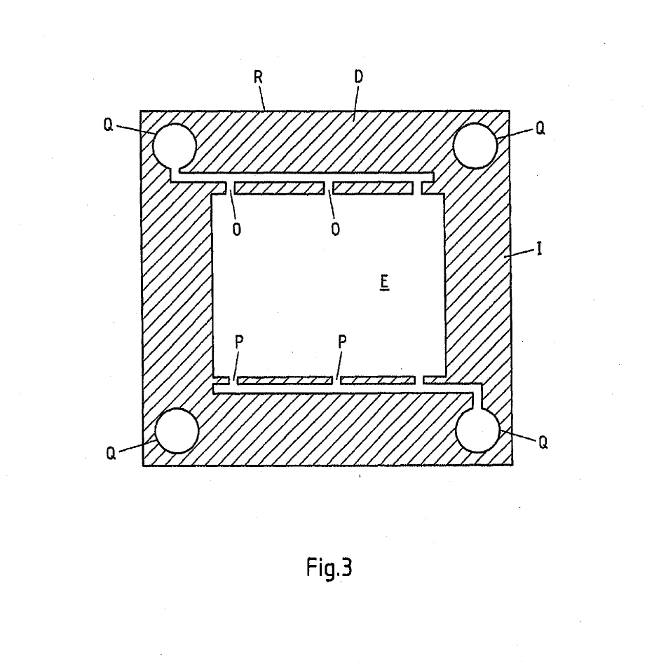

FIG. 3 is a plan view of a cell frame element of the cell stack from FIG. 1,

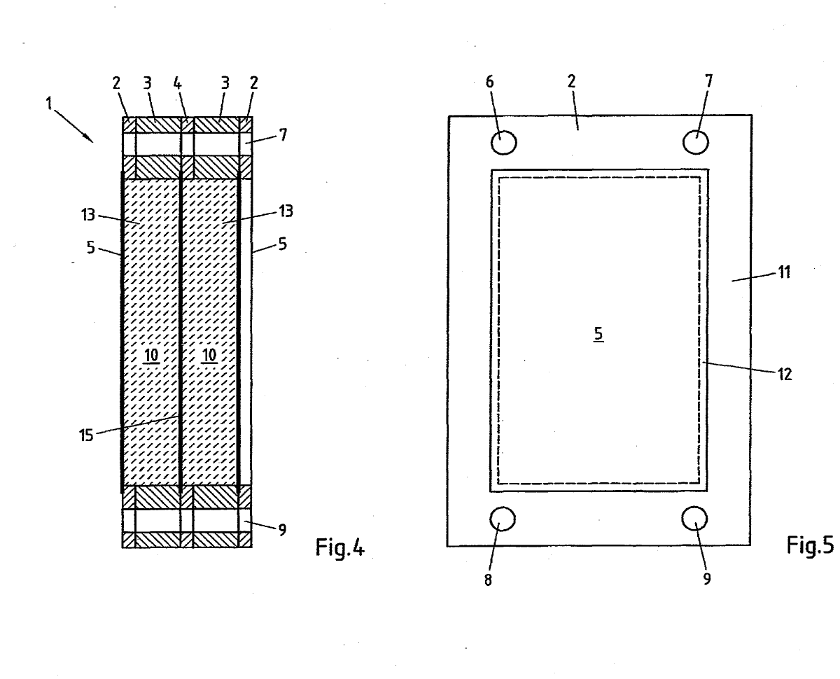

FIG. 4 is a lateral cross-section of a first cell according to the invention of a first cell stack according to the invention,

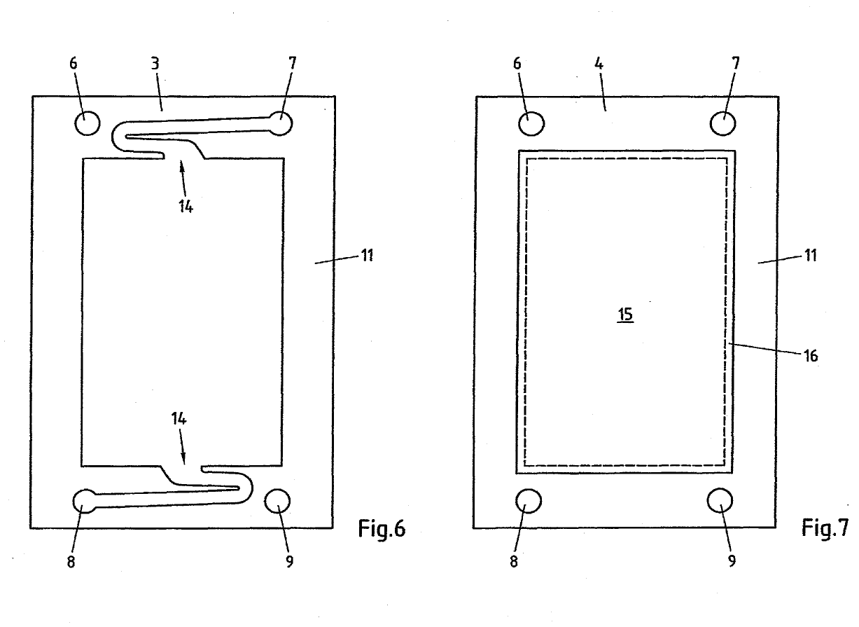

FIG. 5 is a plan view of a first cell frame element of the cell from FIG. 4, FIG. 6 is a plan view of a second cell frame element of the cell from FIG. 4,

FIG. 7 is a plan view of a third cell frame element of the cell from FIG. 4,

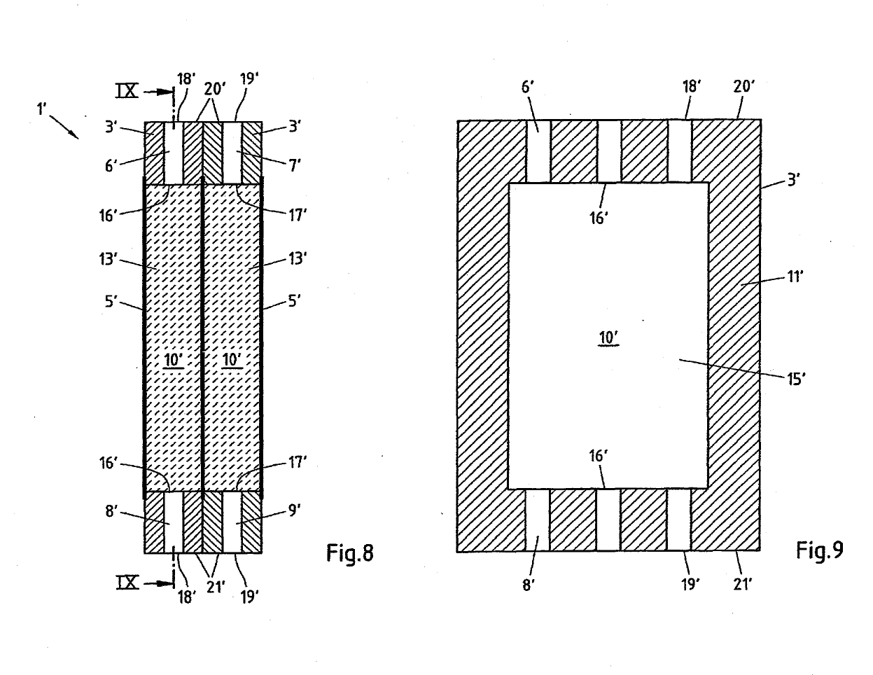

FIG. 8 is a lateral cross-section of a second cell according to the invention of a second cell stack according to the invention,

FIG. 9 is a sectional view of a cell frame element of the cell from FIG. 8,

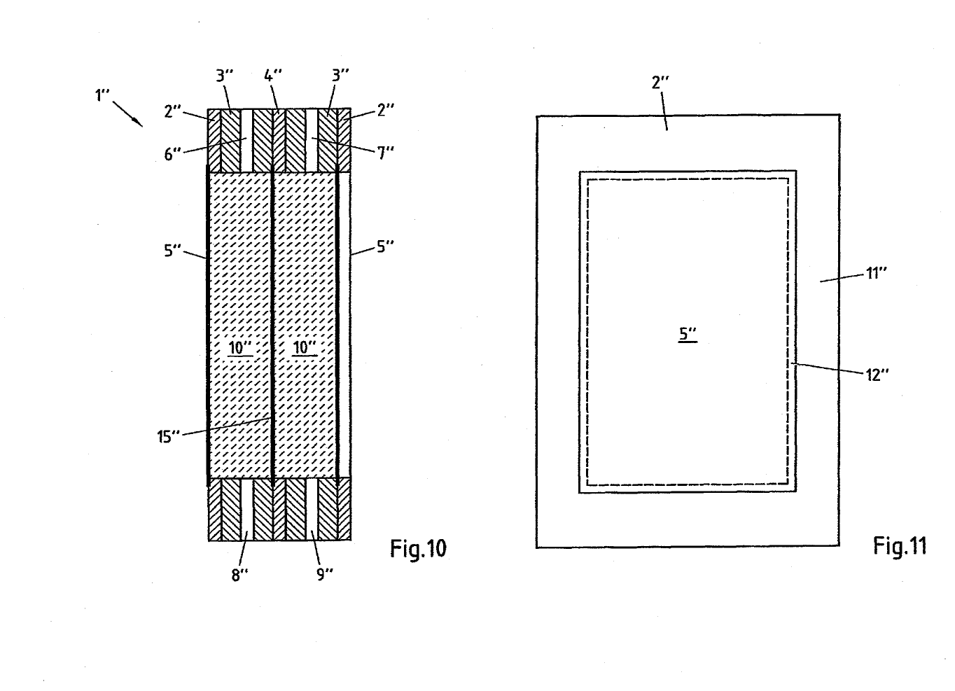

FIG. 10 shows a third cell according to the invention of a third cell stack according to the invention, and

FIG. 11 is a plan view of a cell frame element of the cell from FIG. 10, and

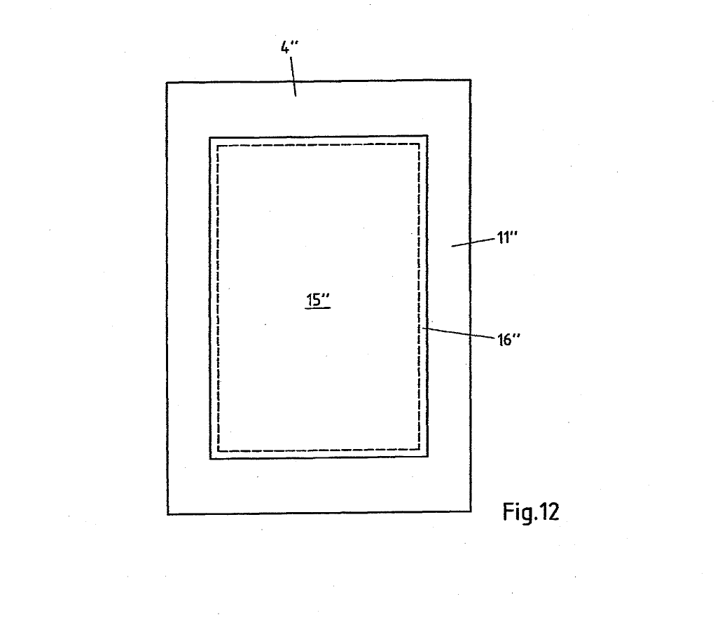

FIG. 12 is a plan view of another cell frame element of the cell from FIG. 10.

FIGS. 1 and 2 are longitudinal sections of a cell stack A, that is to say, a cell stack of a redox flow battery which is known from the prior art and which was described in greater detail in the introduction. The cell stack A comprises three cells B which each have two half-cells C with corresponding electrolytes. Each half-cell C has a cell frame element D which comprises a cell inner space E, through which an electrolyte which is stored in a collection container can be directed. The cell inner space E is closed adjacent to the cell frame element D of the second half-cell C by a semi-permeable membrane F which is provided between the cell frame elements D of the two half-cells C. At the other end side of the cell frame elements D, the half-cells are closed by electrodes G. The electrodes G further close the cell inner spaces E adjacent to the next cell B.

The electrode G is positioned in a planar manner on an outer side H of the cell frame D in the cell stack A illustrated. The electrode G and the end sides of the cell frame elements D adjoin a sealing material 1 at opposing sides of the electrode G. A sealing material J, in which the membrane F is received in a sealing manner, is located between the other end sides of the cell frame elements D.

In the redox flow battery illustrated, four channels extend along the cell stack A for supplying and discharging electrolyte. Distribution channels O, via which the electrolyte can be supplied to the corresponding cell inner space E of the half-cell C, branch off from two channels in a half-cell C of each cell B. At opposing portions of the corresponding cell frames D, there are provided distribution channels P via which the electrolyte can be discharged.

FIG. 3 is a plan view of a cell frame element D of the cell stack from FIG. 1. There are provided in the corners of the cell frame D four holes Q of which each hole forms a portion of a channel for the electrolytes. The branched distribution channels O,P are introduced as recesses in the frame R of the cell frame element D, which frame surrounds the cell inner space E.

FIG. 4 is a cross-section of a cell 1 of a cell stack. The cell 1 comprises five cell frame elements 2, 3, 4. The outer cell frame elements 2 are welded to an electrode 5 in a peripheral manner so that no electrolyte can be discharged between the corresponding cell frame elements 2 and the corresponding electrodes 5. Such a cell frame element 2 welded to an electrode 5 is illustrated in FIG. 5 as a plan view. The cell frame element 2 has four holes in the form of channels 6, 7, 8, 9 which extend substantially perpendicularly to the cell inner space 10 or the electrode 5. Two of those channels 6, 7 are used to supply different electrolytes to the cell inner spaces 10 of the cell 1. The other two channels 8, 9 are used to discharge the two different electrolytes. The electrode 5 is welded to the cell frame element 2 with sufficient spacing from those holes or channels 6, 7, 8, 9 in order to prevent direct contact between electrolytes and the electrode 5. In this instance, the weld seam between the frame 11 of the cell frame element 2 and the edge 12 of the electrode 5 is provided to be peripheral with respect thereto.

The cell frame elements 2 welded to the electrodes 5 are welded to additional cell frame elements 3 in a peripheral manner so that no electrolyte can also be discharged between those cell frame elements 2, 3. The two inner cell frames 3 each form a frame 11 which is provided peripherally with respect to a cell inner space 10. So-called reaction felts 13 are located in the cell inner spaces 10. The cell inner spaces 10 are further a component of different half-cells of the cell 1 (illustrated in FIG. 4) of a cell stack. A corresponding cell frame element 3 is illustrated in FIG. 6 as a plan view of an end side. That cell frame element 3 also has hour holes or channels 6, 7, 8, 9 for the two electrolytes. The holes are arranged in alignment with the holes of the cell frame elements 2 illustrated in FIG. 5. Two of the channels 7, 8 are connected via distribution channels 14 to the cell inner space 10. An electrolyte can be supplied to the cell inner space 10 and can be discharged again via the distribution channels 14. The cell frame element 3 of the other half-cell of the cell 1 of FIG. 4 is orientated in a laterally inverted manner with respect to the cell frame element 3 illustrated in FIG. 6 and is constructed in an identical manner. In this manner, the other electrolyte can be supplied to the other cell inner space 10 via the distribution channels 14 and the other channels 6, 9, and can be discharged again from the cell inner space 10.

An additional cell frame element 4, which is welded to a membrane 15 and which is illustrated in FIG. 7, is provided between the two cell frame elements 3 which peripherally surround the cell inner spaces 10 of the two half-cells of the cell 1. The membrane 15 is provided in such a manner that it closes the cell inner spaces 10 of the half-cells at the side opposite the electrodes 5. The cell frame element 4 which is welded to the membrane 15 is also welded to the two adjacent cell frame elements 3 which form the cell inner spaces 10 of the half-cells. The cell frame element 4 which is welded to the membrane 15 further has, similarly to the cell frame element 2 illustrated in FIG. 5, four holes in the form of channels 6, 7, 8, 9 which are orientated perpendicularly to the membrane plane and in alignment with the other holes. During operation of the cell 1, the electrolytes flow through the channels 6, 7, 8, 9. The membrane 15 is welded in a fluid-tight manner to the frame 11 of the central cell frame element 4 in a peripheral manner along the edge 16.

In an alternative embodiment of the cell which is not illustrated, it would also be possible to dispense with the central cell frame 4 which is welded to the membrane 15. The membrane 15 could then be welded directly to the two cell frame elements 3 which surround the cell inner spaces 10 of the half-cells. In this instance, the cell frame elements 3 which surround the cell inner spaces 10 can further where applicable be welded to each other. Furthermore, if the central cell frame element 4 from FIG. 4 is omitted, it must be ensured that the electrolytes do not become mixed. This can be ensured in that the distribution channels 14 are at least partially closed inwardly by corresponding portions of the cell frame elements 3 and/or in that the distribution channels 14 are at least partially closed by the membrane 15.

FIG. 8 is a cross-section of another cell 1′ of a cell stack. That cell 1′ comprises, unlike the cell illustrated in FIG. 4, only two cell frame elements 3′, as illustrated n FIG. 9 as a sectional view. Those two cell frame elements 3′ peripherally surround, by means of corresponding frames 11′, the cell inner spaces 10′ of the half-cells of the cell 1′ illustrated and each have a plurality of channels 6′, 7′, 8′, 9′ which extend substantially parallel with the cell inner spaces 10′. An electrolyte can be supplied to the cell inner space 10′ through those channels 6′, 7′, 8′, 9′ and can be discharged again from the cell inner space 10′. Since the channels 6′, 7′, 8′, 9′ extend completely in the cell frame elements 3′ and only have openings 16′, 17′ with respect to the cell inner space 10 and openings 18′, 19′ at the narrow sides 20′, 21′ of the cell frame elements 3′, there is no risk of the electrolytes becoming mixed with each other or of undesirable contact between the electrolytes and the electrodes 5′. The cell inner spaces 13′ have reaction felts 13′. The frames 11′ of the cell frame elements 3′ surrounding the cell inner spaces 10′ can therefore be constructed to be relatively narrow. Furthermore, the cell frame elements 3′ can be welded at the end side directly to an electrode 5′ and the membrane 15′ of the cell. Where applicable, the cell frame elements 3′ can further be directly welded to each other.

As a modification with respect to the cell according to FIG. 8, the channels 6′, 7′, 8′, 9′ can be formed without great complexity in the cell frame elements 3′ as channels which are open at one side. The channels 6′, 7′, 8′, 9′ can then be closed at the end side by welding the corresponding cell frame elements 3′ to an electrode 5′ or a membrane 15′.

FIG. 10 is a sectional view of another cell 1″ of a cell stack. The cell 1″ comprises five cell frame elements 2″, 3″, 4″, wherein the two cell frame elements 3″ which peripherally surround the cell inner spaces 10″ of the half-cells correspond to the cell frame element 3′ which is illustrated in FIG. 9. In an outward direction, the cell inner spaces 10″ of the cell frame elements 3″ are closed off by means of an additional cell frame element 2″ illustrated in FIG. 11 and an electrode 5″ which is welded to the additional cell frame element 2″, peripherally at the frame 11″ of the cell frame element 2″ with respect to the edge 12″ of the electrode 5″. The corresponding weld seams between the cell frame elements 2″ and the electrode 5″ are constructed in a fluid-tight manner. Furthermore, the corresponding cell frame elements 2″, 3″ are welded directly to each other in a peripheral manner so that no electrolyte can also be discharged between those cell frame elements 2″, 3″. The frame 11″ of the cell frame element 2″ is constructed to be relatively narrow and manages without any channels for the introduction of electrolyte.

In the centre of the cell 1″, the two half-cells are closed inwardly by a membrane 15″ which is welded to the frame 11″ of an additional cell frame element 4″ illustrated in FIG. 12 in a peripheral manner with respect to the edges 16″ of the membrane 15″. The central cell frame element 4″ is welded not only to the membrane 15″, but also directly and peripherally to the cell frame elements 3″ which are adjacent at both sides. As a result, the cell 1″ illustrated in FIG. 10 is also constructed in a fluid-tight manner with the exception of the channels 6″, 7″, 8″, 9″.

1. A cell of a redox flow battery, comprising at least one cell frame element, a membrane and two electrodes, wherein the at least one cell frame element, the membrane and the two electrodes surround two cell inner spaces which are separate from each other, wherein, in the at least one cell frame element, at least four separate channels are provided in such a manner that different electrolyte solutions can flow through the two cell inner spaces and wherein the cell with the exception of the at least four separate channels is constructed in a fluid-tight manner, wherein at least the at least one cell frame element is welded to the membrane, the two electrodes, and/or to at least one additional cell frame element.

2. The cell according to claim 1, wherein the at least one cell frame element is welded to the membrane, the two electrodes, and/or to at least one additional cell frame element by laser welding, hot air welding, heat element welding and/or ultrasound welding.

3. The cell according to claim 1, wherein the at least one cell frame element, the at least one electrode, and/or the membrane is formed from plastics material and/or a composite material which contains plastics material.

4. The cell according to claim 3, wherein the plastics material is a thermoplastic material, comprising polyethylene (PE), polypropylene (PP), polyphenylene sulphide (PPS), polyether ether ketone, (PEEK), polyvinyl chloride (PVC) and/or polyamide (PA).

5. The cell according to claim 1, wherein the membrane and/or the at least one electrode is injection-moulded or cast so as to be sealed in a fluid-tight manner from a cell frame element, and/or in that the membrane and/or the at least one electrode is retained in a fluid-tight manner by means of pressing between two cell frame elements which are welded to each other.

6. The cell according to claim 1, wherein the at least four channels have openings on at least two narrow sides of the cell and/or at least one cell frame element.

7. The cell according to claim 1, wherein the membrane and/or at least one electrode is welded to at least one cell frame element.

8. The cell according to claim 1, wherein at least two cell frame elements are provided, and wherein a cell frame element is welded to the membrane, to an electrode and to an additional cell frame element which is welded to the additional electrode.

9. The cell according to claim 1, wherein two cell frame elements are welded to each other and/or wherein the membrane is welded to two cell frame elements.

10. The cell according to claim 1, wherein at least two cell frame elements are welded to an electrode and to the membrane, respectively.

11. The cell according to claim 1, wherein at least five cell frame elements are provided, wherein the two electrodes and the membrane are each welded to a separate cell frame element and wherein the five cell frame elements are welded to each other.

12. The cell according to claim 1, wherein the electrode is formed from a composite of a plastics material and conductive particles, in the form of graphite.

13. A cell stack of a redox flow battery, wherein at least one cell according to claim 1 is provided.

14. The cell stack according to claim 13, wherein a cell frame element or an electrode, is welded to a cell frame element of an adjacent cell.

15. The cell stack according to claim 13, wherein the cells are welded at opposing end faces to a cell frame element of an adjacent cell, which element is welded to a membrane.
